(19) United States
(12) Patent Application Publication
(10) Pub. No.: US 2014/0039362 A1
(43) Pub. Date: Feb. 6, 2014

(54) SHRINKER DONNER DEVICE AND METHOD

(71) Applicant: Advanced Orthopedic Products and Services, Inc., Greenville, NC (US)

(72) Inventors: Brian McVeigh, Greenville, NC (US); Aaron Freedlander, Greenville, NC (US)

(73) Assignee: Advanced Orthopedic Products and Services, Inc., Greenville, NC (US)

(21) Appl. No.: 13/957,608

(22) Filed: Aug. 2, 2013

Related U.S. Application Data
(60) Provisional application No. 61/679,402, filed on Aug. 3, 2012.

(51) Int. Cl. A61H 7/00

(52) U.S. Cl. CPC A61H 7/007
USPC 601/134

(57) ABSTRACT

The invention provides a shrinker donner device and method. The shrinker donner device may include, a donner having a substantially tubular body comprising a first end; a second end; a perimeter wall having an outer surface and an inner surface; and an inner region; and a flange extending out from the outer surface of the tubular body and extending around the circumference of the perimeter wall. The method of using the device may include, placing the shrinker in an inner region of a shrinker donner; reversing the shrinker over an outer surface of the shrinker donner, and drawing a proximal end of the shrinker tight across a first end of the shrinker donner; placing the stretched tight shrinker proximal end to a distal end of a residual limb; pushing the shrinker donner forward up the residual limb, and guiding the shrinker off the shrinker donner; and removing the shrinker donner.

### RELATED APPLICATIONS

This application is related and claims priority to U.S. Patent Application No. 61/679,402, filed on Aug. 3, 2012, entitled “Shrinker Donner Device and Method”, the entire disclosure of which is incorporated herein by reference.

### BACKGROUND

The present invention is generally related to a donner device. Specifically, the present invention relates to a shrinker donner device and method to facilitate the donning of a shrinker, such as that used for an amputee's residual limb.

Shrinkers are a compressive sock or sleeve used to reduce, prevent, or control swelling (edema) in the residual limb of an amputee, for example, in the stump of an above or below the knee amputee. The shrinkers are specifically designed to fit snugly and apply pressure to the soft tissues of the stump. Typically, the shrinker is applied to amputee's residual limb within about 2 days post-surgery, and is worn almost continuously while the patient is in the hospital and even for a period of time afterwards as long as the patient has swelling issues. In some patients, especially diabetics, they may continue to have swelling issue all their life and will need to wear the shrinker whenever they are not using their prosthetic.

The typical manner to apply a shrinker to an amputee's residual limb is to manually turn the shrinker inside out and stretch it open by hand and to contact the end of the stump to minimize any tension on the suture line. The lower half of the shrinker is then stretched by hand firmly up towards the knee (in the case of a below the knee amputation), and then the top half of the shrinker is pulled up into position and any wrinkles and/or creases are smoothed out.

Applying a shrinker in the above manner to an amputee's residual limb is a difficult and painful task, especially during the first several days post-surgery. The task is difficult and painful even with the assistance of a caregiver.

It is, thus, desirable to provide an improved device and method for applying a shrinker to an amputee's residual limb.

### SUMMARY OF THE INVENTION

In one embodiment the invention provides a shrinker donner. The shrinker donner device may include, a substantially tubular body comprising a first end; a second end; a perimeter wall having an outer surface and an inner surface; and an inner region; and a flange extending out from the outer surface of the tubular body and extending around the circumference of the perimeter wall. The shrinker donner device may have a length in the range of about 10 inches to about 11 inches. The shrinker donner device may have a diameter in the range of about 6 inches to about 8 inches. The perimeter wall may have a thickness in the range of about ⅛th of an inch. The shrinker donner device may be made of a plastic material. The flange may extend out in a substantially perpendicular manner from the outer surface of the tubular body. The flange may be positioned substantially flush with the second end of the tubular body. The flange may extend in the range of about 1½ inches out from the outer surface of the tubular body. The flange may be in the range of about ⅛th of an inch thick.

In another embodiment the invention provides a method of using a shrinker donner device to apply a shrinker. The method may include, placing the shrinker in an inner region of a shrinker dormer; reversing the shrinker over an outer surface of the shrinker donner, and drawing a proximal end of the shrinker tight across a first end of the shrinker donner; placing the stretched tight shrinker proximal end to a distal end of a residual limb stump; pushing the shrinker donner forward up the residual limb stump, and guiding the shrinker off the shrinker dormer; and removing the shrinker donner. A user may grasp the shrinker donner by a flange thereon to facilitate placing the shrinker donner. The user may grasp the shrinker donner with one hand by a flange thereon and guide the shrinker off the shrinker donner with the other hand. The method may further include adjusting the shrinker once applied to the residual limb stump and smoothing out any wrinkles and/or creases.

### BRIEF DESCRIPTION OF THE DRAWINGS

FIG. 1A illustrates a side perspective view of a shrinker donner device of the present invention;

FIG. 1B illustrates a first end perspective view of the shrinker donner device of the present invention;

FIG. 2 shows a flow diagram of a method of applying a shrinker to a residual limb using the shrinker donner device of the present invention; and

FIG. 3A-3D illustrates the method of applying the shrinker to a residual limb using the shrinker donner device.

### DESCRIPTION

In accordance with one embodiment of the invention, a shrinker donner device is provided that provides an improved device for applying a shrinker to the residual limb (stump) of a post-surgical amputee, for example to the stump of an above or below the knee leg amputee.

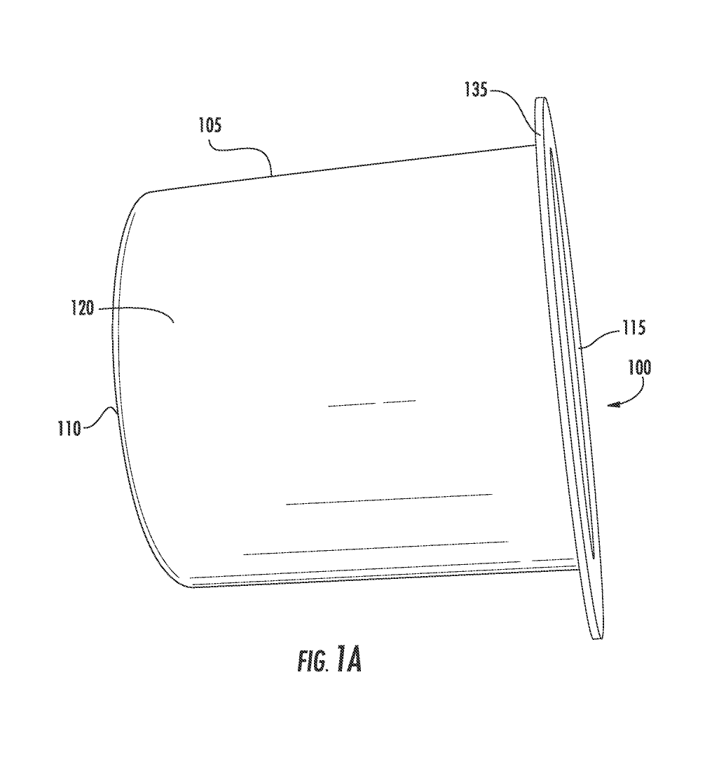

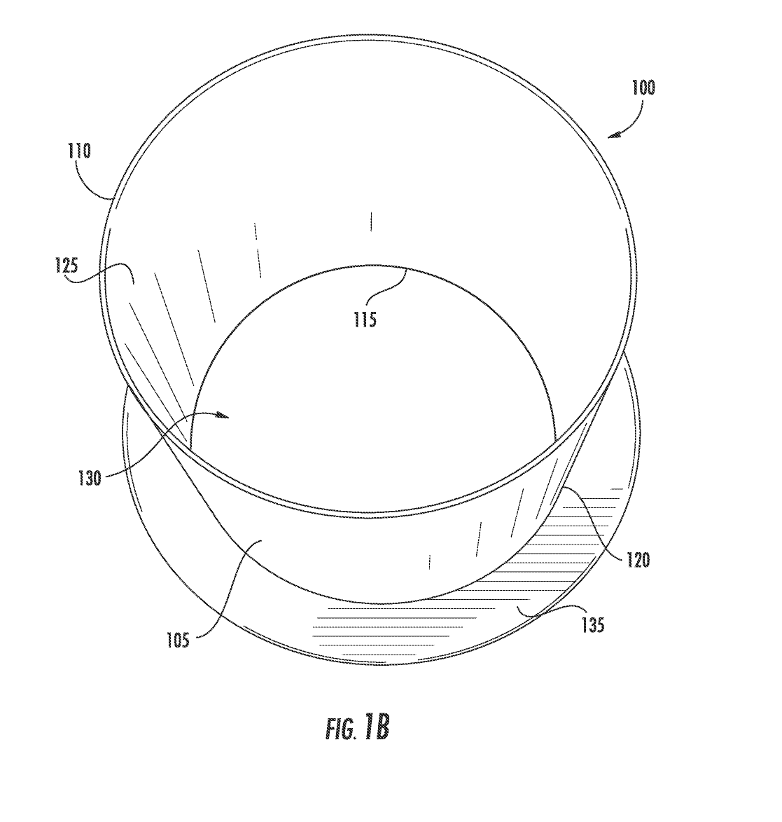

The shrinker donner device and method will be described in more detail below with reference to FIGS. 1A and 1B. Shrinker donner device 100 is a donner having a substantially a tubular body and includes a first end 110, a second end 115, a perimeter wall 105 having an outer surface 120 and an inner surface 125, and an inner region 130. Shrinker donner device 100 further includes a flange 135 that extends out from outer surface 120, and extends at least partially around the circumference of perimeter wall 105, and preferably substantially around the circumference of perimeter wall 105.

Shrinker donner device 100 may have a length in the range of about 10 inches to about 11 inches, and may have a diameter in the range of about 6 inches to about 8 inches. Perimeter wall 105 may have a thickness in the range of about ⅛th of an inch. In one example, a shrinker donner 100 having about a 6 inch diameter may be used for applying a shrinker to the residual limb of a below the knee amputee. In another example, a shrinker donner 100 having about an 8 inch diameter may be used for applying a shrinker to the residual limb of an above the knee amputee. In other embodiments, shrinker donner device 100 may have a length less than about 10 inches and greater than about 11 inches and may have a diameter less than about 6 inches and greater than about 8 inches, and perimeter wall 105 may have a thickness greater or less than about ⅛th of an inch.

Shrinker donner device 100 is preferably made of a durable plastic material. However, other materials, such as but limited to aluminum, steel, or other suitable materials may be used. In an alternative embodiment a shrinker donner device 100 made of aluminum or steel, or other like material, may also be coated with a powder coat, for example, to provide a low friction surface to facilitate application of the shrinker. Powder coating provides a low friction surface and stands up to the sterilization processes, such as an autoclave, better than paints or other such coatings. Other coatings that are capable of providing a suitably slick surface and are able to stand up to the sterilization process may alternatively be used to coat shrinker donner device 100.

Flange 135 preferably extends out in a substantially perpendicular manner from outer surface 120, and is preferably positioned in proximity, such as substantially flush with, second end 115. Flange 135, in an alternate embodiment, may be spaced in the range of about 1½ inches to about 2½ inches from second end 115. Flange 135 may extend in the range of about 1½ inches out from outer surface 120, and may be in the range of about ⅛ th of an inch thick. Flange 135 may be attached to outer surface 120, by a weld, or by other suitable attachment hardware or methods know in the art. Alternatively, flange 135 may be formed on outer surface 120.

The above numerical dimensions associated with the shrinker donner device 100 are only examples of some preferable ranges, and it should be noted that other suitable dimensions greater or less than the example ranges noted, may be used and are contemplated to be within the scope of the invention.

In accordance with another embodiment of the invention, a method of applying a shrinker is provided.

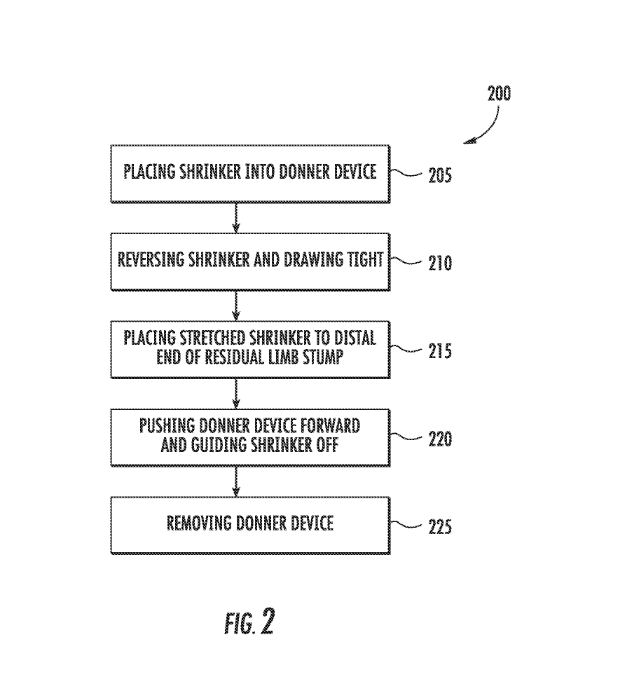

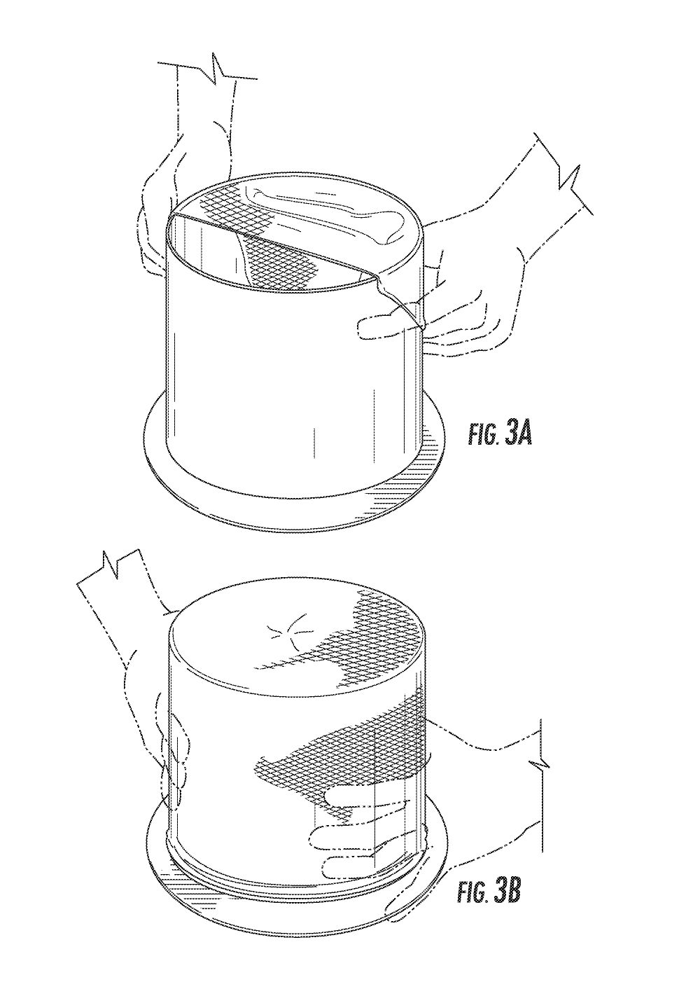

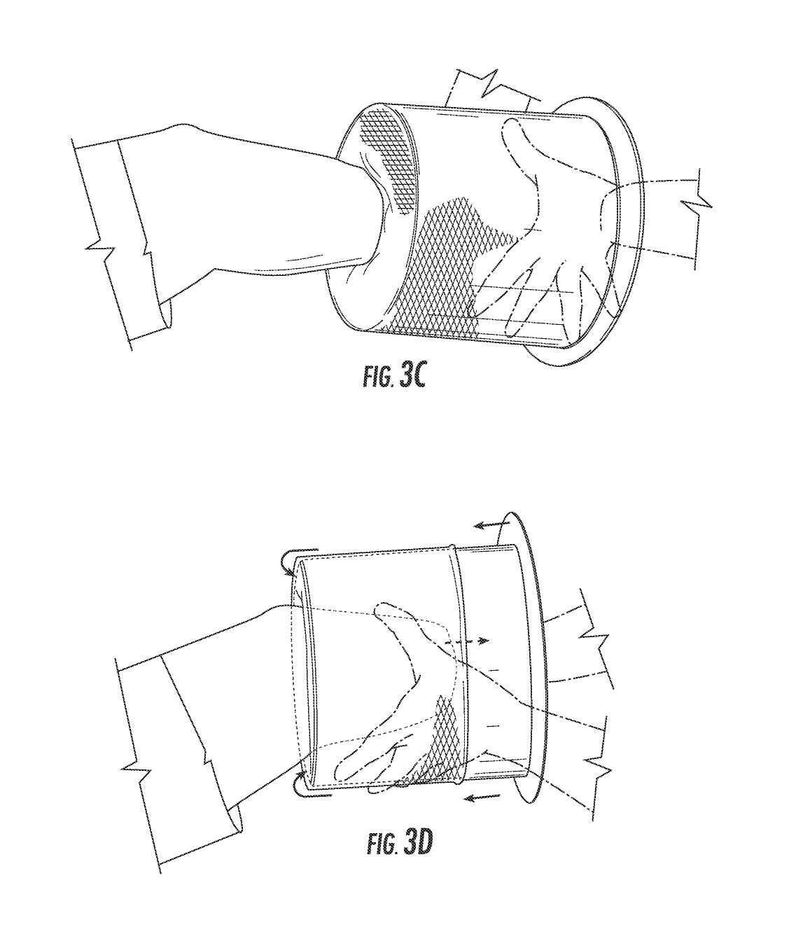

The method of applying a shrinker will be described in more detail below with reference to FIGS. 2 and 3A-D. The method 200 includes:

205: Placing a shrinker in inner region 130 of shrinker donner device 100. In this step, a patient or caregiver, such as a doctor, nurse, or the like, places the shrinker, proximal end first, into inner region 130 of shrinker donner device 100, as shown in FIG. 3A.

210: Reversing the shrinker over the outer surface 120 of shrinker donner device 100. In this step, a patient or caregiver reverses the shrinker over the outer surface 120 of shrinker donner device 100 and draws the shrinker proximal end tight across first end 110 of shrinker donner device 100, as shown in FIG. 3B.

215: Placing the stretched tight shrinker proximal end to a distal end of the stump. In this step, a patient or caregiver places the stretched tight shrinker proximal end to the distal end of the stump to which the shrinker is to be applied, as shown in FIG. 3C. In this step, the patient or caregiver may grasp shrinker donner device 100 by flange 135 to facilitate placing the shrinker donner device 100.

220: Pushing shrinker donner device 100 forward. In this step, a patient or caregiver pushes shrinker donner device 100 forward toward a proximal end of the stump, while guiding the shrinker off the shrinker donner device 100, as shown in FIG. 3D. In this step, the patient or caregiver may grasp shrinker donner device 100 with one hand by flange 135 and guides the shrinker off the shrinker donner device 100 with the other hand.

225: Removing shrinker donner device 100. In this step, a patient or caregiver removes the shrinker donner device 100 from the patient's stump. If necessary, the patient or caregiver makes any necessary adjustments and smoothing out wrinkles and/or creases.

Concluding Remarks

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

What is claimed is:

1. A shrinker donner device comprising:
a. a donner having a substantially tubular body comprising a first end; a second end; a perimeter wall having an outer surface and an inner surface; and an inner region; and
b. a flange extending out from the outer surface of the tubular body and extending substantially around the circumference of the perimeter wall.

2. The shrinker donner device of claim 1 wherein the donner has a length in the range of about 10 inches to about 11 inches.

3. The shrinker donner device of claim 1 wherein the donner has a diameter in the range of about 6 inches to about 8 inches.

4. The shrinker donner device of claim 1 wherein the perimeter wall has a thickness in the range of about ⅛th of an inch.

5. The shrinker donner device of claim 1 wherein the shrinker donner device comprises a plastic material.

6. The shrinker donner device of claim 1 wherein the flange extends out in a substantially perpendicular manner from the outer surface of the tubular body.

7. The shrinker donner device of claim 1 wherein the flange is positioned substantially flush with the second end of the tubular body.

8. The shrinker donner device of claim 1 wherein the flange extends in the range of about 1½ inches out from the outer surface of the tubular body

9. The shrinker donner device of claim 1 wherein the flange is in the range of about ⅛th of an inch thick.

10. A method of applying a shrinker, comprising:
a. placing the shrinker in an inner region of a shrinker donner device, the shrinker donner device, comprising:
i. a donner having a substantially tubular body comprising a first end; a second end; a perimeter wall having an outer surface and an inner surface; and an inner region; and
ii. a flange extending out from the outer surface of the tubular body and extending substantially around the circumference of the perimeter wall;
b. reversing the shrinker over the outer surface of the shrinker donner, and drawing a proximal end of the shrinker tight across the first end of the shrinker donner;
c. placing the stretched tight shrinker proximal end to a distal end of a residual limb;
d. pushing the shrinker donner forward up the residual limb, and guiding the shrinker off the shrinker donner; and
e. removing the shrinker donner.

11. The method of claim 10 wherein a user grasps the shrinker donner by the flange thereon to facilitate placing the shrinker donner.

12. The method of claim 10 wherein a user grasps the shrinker donner with one hand by the flange thereon and guides the shrinker off the shrinker donner with the other hand.

13. The method of claim 10 wherein the donner has a length in the range of about 10 inches to about 11 inches.

14. The method of claim 10 wherein the donner has a diameter in the range of about 6 inches to about 8 inches.

15. The method of claim 10 wherein the perimeter wall has a thickness in the range of about ⅛th of an inch.

16. The method of claim 10 wherein the shrinker donner device comprises a plastic material.

17. The method of claim 10 wherein the flange extends out in a substantially perpendicular manner from the outer surface of the tubular body.

18. The method of claim 10 wherein the flange is positioned substantially flush with the second end of the tubular body.

19. The method of claim 10 wherein the flange extends in the range of about 1½ inches out from the outer surface of the tubular body

20. The method of claim 10 wherein the flange is in the range of about ⅛th of an inch thick.
